(19) United States
(12) Patent Application Publication
(10) Pub. No.: US 2026/0109381 A1
(43) Pub. Date: Apr. 23, 2026

(54) FOLDING WHEELBARROW

(71) Applicants: Chester Lemley, China Grove, NC (US); Patricia Lemley, China Grove, NC (US)

(72) Inventors: Chester Lemley, China Grove, NC (US); Patricia Lemley, China Grove, NC (US)

(21) Appl. No.: 18/919,907

(22) Filed: Oct. 18, 2024

(51) Int. Cl. B62B 1/20

(52) U.S. Cl. CPC B62B 1/208; B62B 1/202; B62B 1/206; B62B 2205/006; B62B 2205/10; B62B 2205/30

(57) ABSTRACT

A foldable wheelbarrow, including a frame portion, a tray portion detachably coupled to top portions of the frame portion to store objects therein, an axle detachably coupled to a front end of the frame portion, and a wheel detachably and spinnably connected to the axle at the front end of the frame portion, such that the wheel is spinnable to allow the folding wheelbarrow to move.

### BACKGROUND

### 1. Field

The present general inventive concept relates generally to a wheelbarrow, and particularly, to a folding wheelbarrow.

### 2. Description of the Related Art

Conventional wheelbarrows can be difficult to maneuver and store, especially for individuals with limited strength or mobility to manage such a hefty and bulky tool.

Furthermore, the standard size of a wheelbarrow requires ample storage space which is not often readily available for private homeowners that use bulky equipment.

Therefore, there is a need for a wheelbarrow that is easily storable.

### SUMMARY

The present general inventive concept provides a folding wheelbarrow.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a foldable wheelbarrow, including a frame portion, a tray portion detachably coupled to top portions of the frame portion to store objects therein, an axle detachably coupled to a front end of the frame portion, and a wheel detachably and spinnably connected to the axle at the front end of the frame portion, such that the wheel is spinnable to allow the folding wheelbarrow to move.

The tray portion may include a base portion to detachably couple to the top portions of the frame portion, a first foldable side to detachably couple to a first side edge of the base portion, a second foldable side to detachably couple to a second side edge of the base portion, a fixed rear portion to connect to a back edge of the base portion, a back edge of the first foldable side, and a back edge of the second foldable side, a fixed front portion to connect to a front edge of the base portion, a front edge of the first foldable side, and a front edge of the second foldable side, a hinge connected to a top edge of the fixed front portion, and a foldable front portion to connect to the hinge to allow the foldable front portion to hingedly move and fold with respect to the fixed front portion.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric perspective view of a foldable wheelbarrow, according to an exemplary embodiment of the present general inventive concept; and

FIG. 2 illustrates an isometric exploded view of the foldable wheelbarrow of FIG. 1, according to an exemplary embodiment of the present general inventive concept;

FIG. 3 illustrates an isometric exploded view of the foldable wheelbarrow of FIG. 1 in a folded arrangement, according to an exemplary embodiment of the present general inventive concept; and

FIG. 4 illustrates an isometric view of the foldable wheelbarrow of FIG. 1 in a fully folded and combined arrangement, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,”“adjacent”versus “directly adjacent,”etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Foldable Wheelbarrow 100
Tray Portion 110
First Foldable Side 111
First Foldable Side End Wedges 111a
First Foldable Side End Grooves 111b
First Foldable Side Bottom Wedges 111c
First Foldable Side Bottom Grooves 111d
Second Foldable Side 112
Second Foldable Side End Wedges 112a
Second Foldable Side End Grooves 112b
Second Foldable Side Bottom Wedges 112c
Second Foldable Side Bottom Grooves 112d
Fixed Back 113
Fixed Back Bottom Lateral Rod 113a
Fixed Back Top Lateral Rod 113b
Fixed Front Portion 114
Fixed Front Portion Later Rod 114a
Foldable Front Portion 115
Foldable Front Portion First Wedges 115a
Foldable Front Portion First Grooves 115b
Foldable Front Portion Second Wedges 115c
Foldable Front Portion Second Grooves 115d
Hinged Portion 115e
Base Portion 116
Base Portion First Wedges 116a
Base Portion First Grooves 116b
Base Portion Second Wedges 116c
Base Portion Second Grooves 116d
Frame Portion 120
First Handle 121
Second Handle 122
First Foldable Support 123
First Foldable Support First Arm 123a
First Foldable Support Second Arm 123b
First Foldable Support First Arm Handle Connecting Member 123c
First Foldable Support Second Arm Handle Connecting Member 123d
First Foldable Support Arm Connecting Member 123e
Second Foldable Support 124
Second Foldable Support First Arm 124a
Second Foldable Support Second Arm 124b
Second Foldable Support First Arm Handle Connecting Member 124c
Second Foldable Support Second Arm Handle Connecting Member 124d
Second Foldable Support Arm Connecting Member 124e
Axle 130
Cotter Pin 140
Wheel 150

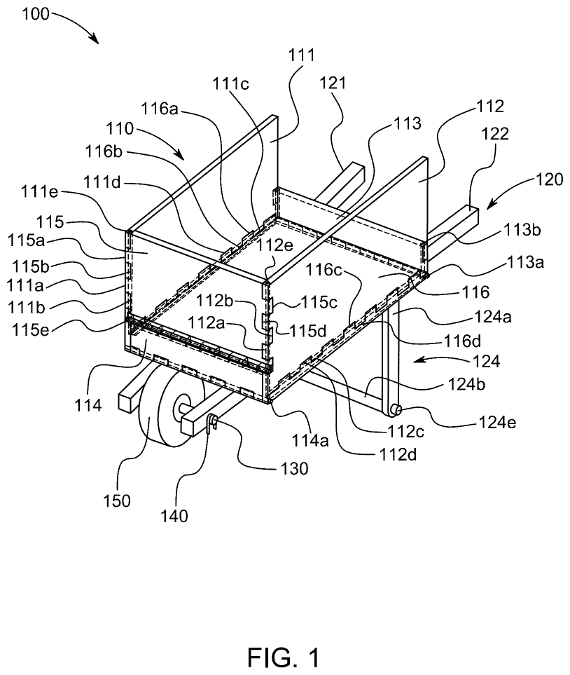

FIG. 1 illustrates an isometric perspective view of a foldable wheelbarrow 100, according to an exemplary embodiment of the present general inventive concept.

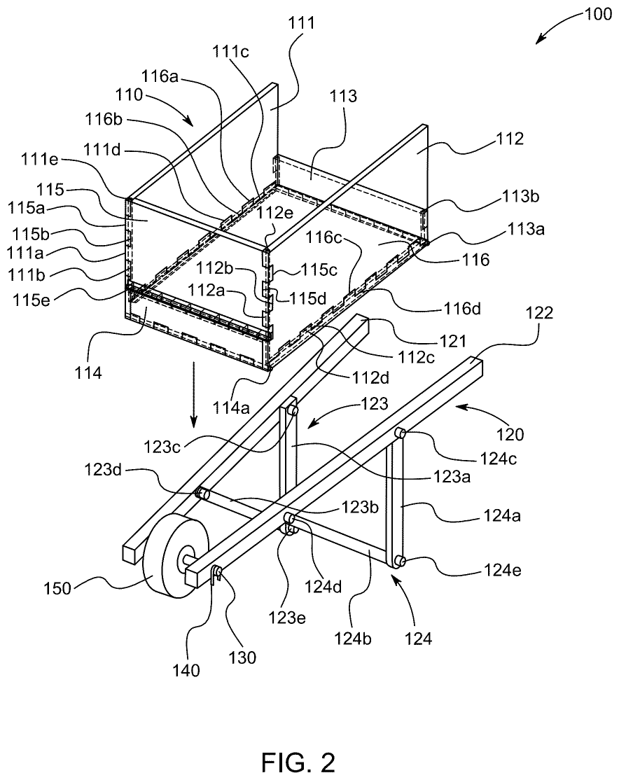

FIG. 2 illustrates an isometric exploded view of the foldable wheelbarrow 100 of FIG. 1, according to an exemplary embodiment of the present general inventive concept.

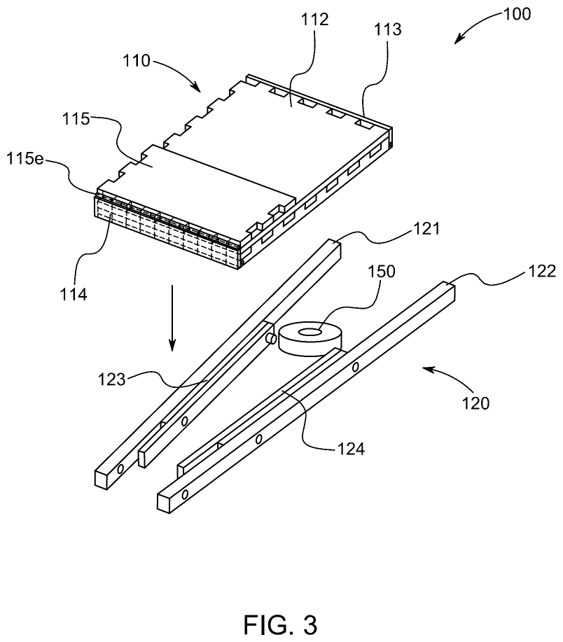

FIG. 3 illustrates an isometric exploded view of the foldable wheelbarrow 100 of FIG. 1 in a folded arrangement, according to an exemplary embodiment of the present general inventive concept.

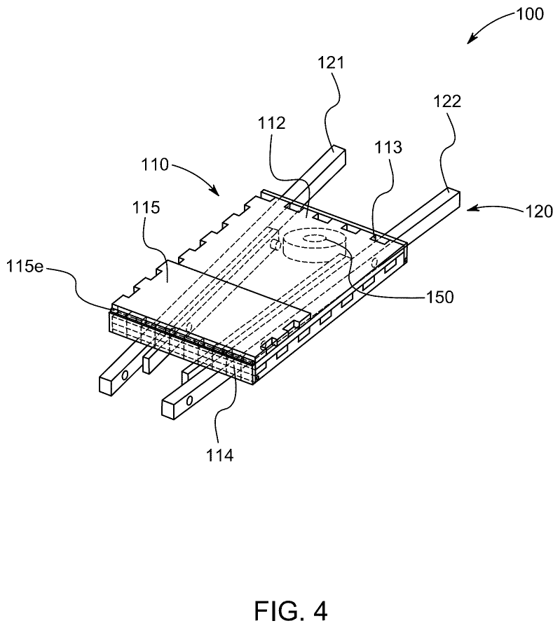

FIG. 4 illustrates an isometric view of the foldable wheelbarrow 100 of FIG. 1 in a fully folded and combined arrangement, according to an exemplary embodiment of the present general inventive concept.

The foldable wheelbarrow 100, and all components therein and/or connected thereto, may be constructed from at least one of metal, plastic, stone, ceramics, wood, silicone, glass, paper, cloth, circuitry, leather, memory foam, latex, and rubber, etc., but is not limited thereto, and can be constructed from any material known to one of ordinary skill in the art.

Referring to FIGS. 1 through 4, the foldable wheelbarrow 100 may include a tray portion 110, a frame portion 120, an axle 130, a cotter pin 140, and a wheel 150, but is not limited thereto.

The tray portion 110 may be designed to attach to (i.e., to connect to, to couple to, to fix to, to affix to, etc.) top portions of the frame portion 120, in order to create the foldable wheelbarrow 100 as depicted in FIG. 1.

The tray portion 110 may include a first foldable side 111, a second foldable side 112, a fixed back 113, a fixed front portion 114, a foldable front portion 115, and base portion 116, but is not limited thereto.

The first foldable side 111 may include first foldable side end wedges 111a, first foldable side end grooves 111b, first foldable side bottom wedges 111c, and first foldable side bottom grooves 111d, but is not limited thereto.

The second foldable side 112 may include second foldable side end wedges 112a, second foldable side end grooves 112b, second foldable side bottom wedges 112c, and second foldable side bottom grooves 112d, but is not limited thereto.

The fixed back 113 may include a fixed back bottom lateral rod 113 and fixed back top lateral rod 113b, but is not limited thereto.

The fixed front portion 114 may include a fixed front portion later rod 114a, but is not limited thereto.

The foldable front portion 115 may include foldable front portion first wedges 115a, foldable front portion first grooves 115b, foldable front portion second wedges 115c, foldable front portion second grooves 115d, and a hinged portion 115e, but is not limited thereto.

The base portion 116 may include base portion first wedges 116a, base portion first grooves 116b, base portion second wedges 116c, and base portion second grooves 116d, but is not limited thereto.

Construction of the tray portion 110 will be hereinafter described.

A bottom edge portion of the first foldable side 111 may be connected to a first side edge of the base portion 116, and a bottom edge portion of the second foldable side 112 may be connected to a second side edge of the base portion 116.

A front edge portion of the first foldable side 111 may be connected to a first side edge of the foldable front portion 115, and a front edge portion of the second foldable side 112 may be connected to a second side edge of the foldable front portion 115.

Specifically, to attach the first foldable side 111 to the foldable front portion 115 and the base portion 116, the first foldable side end wedges 111a may be inserted into the foldable front portion first grooves 115b, the first foldable side end grooves 111b may receive the foldable front portion first wedges 115a therein, the first foldable side bottom wedges 111c may be inserted into the base portion first grooves 116b, and the first foldable side bottom grooves 111d may receive the base portion first wedges 116a therein.

Specifically, to attach the second foldable side 112 to the foldable front portion 115 and the base portion 116, the second foldable side end wedges 112a may be inserted into the foldable front portion second grooves 115d, the second foldable side end grooves 112d may receive the foldable front portion second wedges 115c therein, the second foldable side bottom wedges 112c may be inserted into the base portion second grooves 116d, and the second foldable side bottom grooves 111d may receive the base portion second wedges 116c therein.

The foldable front portion 115 may be above and connected to the fixed front portion 114 via the hinged portion 115e, such that the foldable front portion 115 swingedly moves independently with respect to the fixed front portion 114.

The fixed back 113 may include a fixed back bottom lateral rod 113 and fixed back top lateral rod 113b, but is not limited thereto.

The fixed back 113 may be connected between the front foldable side 111 and the second foldable side 112 via the fixed back bottom lateral rod 113 and fixed back top lateral rod 113b, which may laterally extend from first ends of the fixed back 113 to second ends of the fixed back 113. Thus, the entire back portion of the tray portion 110 is constructed.

The fixed front portion 114 may be connected between the front foldable side 111 and the second foldable side 112 via the fixed front portion later rod 114a, which may laterally extend from a first end of the fixed front portion 114 to a second end of the fixed front portion 114. Thus, the entire front portion of the tray portion 110 is constructed.

The frame portion 120 may include a first handle 121, a second handle 122, a first foldable support 123, and a second foldable support 124, but is not limited thereto.

The first foldable support 123 may include a first foldable support first arm 123a, a first foldable support second arm 123b, a first foldable support first arm handle connecting member 123c, a first foldable support second arm handle connecting member 123d, and a first foldable support arm connecting member 123e, but is not limited thereto.

The first foldable support 123 may be connected to a center portion of the first handle 121 by connecting a first end of the first foldable support first arm 123a via the first foldable support first arm handle connecting member 123c, connecting a first end of the first foldable support second arm 123b via the first foldable support second arm handle connecting member 123d, and then connecting the first foldable support arm connecting member 123e to second ends of the first foldable support first arm 123a and the first foldable support second arm 123b, respectively.

The second foldable support 124 may include a second foldable support first arm 124a, a second foldable support second arm 124b, a second foldable support first arm handle connecting member 124c, a second foldable support second arm handle connecting member 124d, and a second foldable support arm connecting member 124e, but is not limited thereto.

The second foldable support 124 may be connected to a center portion of the second handle 122 by connecting a first end of the second foldable support first arm 124a via the second foldable support first arm handle connecting member 124c, connecting a first end of the second foldable support second arm 124b via the second foldable support second arm handle connecting member 124d, and then connecting the second foldable support arm connecting member 124e to second ends of the second foldable support first arm 124a and the second foldable support second arm 124b, respectively.

In order to attach the wheel 150 to the foldable wheelbarrow 100, the axle 130 may be threaded through end portions of the first handle 121 and the second handle 122 (i.e., end portions of the first handle 121 and the second handle 122 that are further away from the portions of the first handle 121 and the second handle 122 that a user grips while moving the foldable wheelbarrow 100), such that the axle 130 first threads through the first handle 121, then through a middle portion of the wheel 150, and then through the second handle 122. The axle 130 may be held in place by the cotter pin 140 being inserted perpendicularly though the axle 130.

The present general inventive concept may include a foldable wheelbarrow 100, including a frame portion 120, a tray portion 110 detachably coupled to top portions of the frame portion 120 to store objects therein, an axle 130 detachably coupled to a front end of the frame portion 120, and a wheel 150 detachably and spinnably connected to the axle 130 at the front end of the frame portion 120, such that the wheel 150 is spinnable to allow the folding wheelbarrow 100 to move.

The tray portion 110 may include a base portion 116 to detachably couple to the top portions of the frame portion 120, a first foldable side 111 to detachably couple to a first side edge of the base portion 116, a second foldable side 112 to detachably couple to a second side edge of the base portion 116, a fixed rear portion 113 to connect to a back edge of the base portion 116, a back edge of the first foldable side 111, and a back edge of the second foldable side 112, a fixed front portion 114 to connect to a front edge of the base portion 116, a front edge of the first foldable side 111, and a front edge of the second foldable side 112, a hinge 115e connected to a top edge of the fixed front portion 114, and a foldable front portion 115 to connect to the hinge 115e to allow the foldable front portion 115 to hingedly move and fold with respect to the fixed front portion 114.

A main purpose of the present general inventive concept is to provide users with a foldable wheelbarrow that allows users to easily store their wheelbarrow on a wall when not in use. Ingenious and practical, the present general inventive concept offers a modern wheelbarrow design that frees up valuable floor space in garages, sheds, or other storage areas by ensuring users are able to easily store their wheelbarrow on a wall when it is not being utilized. Expanding on the initial design of an average wheelbarrow, the present general inventive concept introduces a novel option that features a collapsible frame, allowing the tool to be folded up for compact storage. Post use of the wheelbarrow, a person can simply fold the present general inventive concept and hang it on a wall using the included mounting hardware. With its compact malleable construction, users can quickly and effortlessly hang the wheelbarrow on a wall, ensuring that it is always accessible when needed for gardening, landscaping, or other outdoor tasks. This innovative, top-quality product features a lightweight and easy-to-use design and provides homeowners and gardeners with a convenient way to store and manage the use of a wheelbarrow, in an organized and accessible manner, while maximizing storage space. As a result, the present general inventive concept may prove to be essential in the tools/gadgets industry.

The present general inventive concept is the only product of its kind that offers a practical solution to the challenges of storing a wheelbarrow. This unprecedented product is uniquely designed with high-quality materials, including a sturdy frame and durable high terrain wheels to ensure the wheelbarrow is capable of handling heavy loads and tough outdoor conditions.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A foldable wheelbarrow, comprising:
a frame portion;
a tray portion detachably coupled to top portions of the frame portion to store objects therein;
an axle detachably coupled to a front end of the frame portion; and
a wheel detachably and spinnably connected to the axle at the front end of the frame portion, such that the wheel is spinnable to allow the folding wheelbarrow to move.

2. The foldable wheelbarrow of claim 1, wherein the tray portion
comprises: a base portion to detachably couple to the top portions of the frame portion;
a first foldable side to detachably couple to a first side edge of the base portion;
a second foldable side to detachably couple to a second side edge of the base portion;
a fixed rear portion to connect to a back edge of the base portion, a back edge of the first foldable side, and a back edge of the second foldable side;
a fixed front portion to connect to a front edge of the base portion, a front edge of the first foldable side, and a front edge of the second foldable side;
a hinge connected to a top edge of the fixed front portion; and
a foldable front portion to connect to the hinge to allow the foldable front portion to hingedly move and fold with respect to the fixed front portion.
